(19) United States
(12) Patent Application Publication
(10) Pub. No.: US 2025/0184236 A1
(43) Pub. Date: Jun. 5, 2025

(54) INTEGRATING A 3GPP SYSTEM INTO A DETERMINISTIC NETWORK ARCHITECTURE

(71) Applicant: Telefonaktiebolaget LM Ericsson (publ), Stockholm (SE)

(72) Inventors: György MIKLÓS, Pilisborosjenö (HU); Balázs VARGA, Budapest (HU); János FARKAS, Kecskemét (HU)

(73) Assignee: Telefonaktiebolaget LM Ericsson (publ), Stockholm (SE)

(21) Appl. No.: 18/862,038

(22) PCT Filed: May 2, 2023
(86) PCT No.: PCT/EP2023/061454

§ 371 Date: Oct. 31, 2024

Related U.S. Application Data
(60) Provisional application No. 63/337,438, filed on May 2, 2022.

(51) Int. Cl. H04L 41/34; H04L 41/12; H04L 41/40; H04W 40/24; H04W 48/18

(52) U.S. Cl. CPC H04L 41/34; H04L 41/12; H04L 41/40; H04W 40/246; H04W 48/18

(57) ABSTRACT

A method performed by a network node is provided. The method comprises obtaining first information comprising port information and/or node information. The port information includes at least one port identifier identifying at least one port which is assigned to a Packet Data Unit, PDU, session and/or which is associated with a user plane function, UPF. The node information includes a node identifier identifying a user plane function, UPF. The method further comprises transmitting towards a deterministic network, Det-Net, controller second information generated based on the first information.

### TECHNICAL FIELD

This disclosure relates to methods, apparatus, and/or systems for integrating a 3rd Generation Partnership Project (3GPP) system into a deterministic network (DetNet) architecture.

### BACKGROUND

Nowadays, many applications and services rely on transmitting and/or receiving data via a network. For example, there may be a scenario where a doctor locating at a remote location performs a surgery using a robot that is remotely controlled by the doctor via a network. In another example, there may be a scenario where an operator located at a remote location controls a drone by sending commands to the drone via a network.

Among those applications and services, some applications and services may require low latency on transmitting and/or receiving data via a network. For example, in the above scenario, it is important to send commands to the drones in order to change the moving direction of the drones with low latency as any delay in the transmission of the commands may result in the drones colliding an obstacle in its path. In such applications and services, there is a need for the delivery of a reliable and predictable network services.

In order to deliver reliable and predictable network services, a deterministic network (DetNet) may be used. DetNet networks provide guaranteed latency on a per-deterministic-flow basis, and the data traffic of each deterministic flow is delivered within a guaranteed bounded latency and low delay variation constraint. In order to maintain low latency and delay, DetNet may reject or degrade some flows.

SUMMARY

As Fifth Generation (5G) infrastructure and device availability mature, there may be a need to integrate a 5G system (5GS) into a DetNet architecture such that the benefit of high speed data transmission of 5GS can be provided together with the benefit of low data exchange latency provided by a DetNet architecture. However, there is currently no way for the 5GS to provide node and port information as well as neighbor information to a DetNet architecture in order to help a controller of the DetNet architecture to determine network topology of the 5GS.

In 3GPP release 16, time sensitive network (TSN) interworking (see 3GPP TS 23.501 version 17.4.0at sections 4.4.8 and 5.27 and 5.27), the use of link layer discovery protocol (LLDP) was defined to support topology discovery. However, LLDP is mostly used for layer 2 Ethernet networks, and not generally used in IP networks. Further, the information provided in the 3GPP release 17 about the network node and its interfaces does not cover the needed parameters for IP networks, since 3GPP only provides TSN integration for Ethernet as well as direct application interworking where node and topology information is not required.

Accordingly, in one aspect of the embodiments of this disclosure, there is provided a method performed by a network node. The method comprises obtaining information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The method further comprises transmitting the information towards a deterministic network, DetNet, controller.

In another aspect, there is provided a method performed by a network node. The method comprises generating information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The method further comprises transmitting the information towards a session management function, SMF.

In another aspect, there is provided a method performed by a network node. The method comprises obtaining information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The method further comprises transmitting the information towards a policy control function, PCF.

In another aspect, there is provided a method performed by a network node. The method comprises obtaining information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The method further comprises transmitting the information towards a time sensitive communication and time synchronization function, TSCTSF.

In another aspect, there is provided a method performed by a deterministic network, DetNet, controller. The method comprises receiving information comprising port information and/or node information, wherein the information was transmitted by a network node, the port information includes at least one port identifier identifying at least one port which is assigned to a Packet Data Unit, PDU, session and/or which is associated with a user plane function, UPF, and the node information includes a node identifier identifying the UPF. The method further comprises, using the received information, generating topology information indicating topology of the logical network node.

In another aspect, there is provided a computer program comprising instructions which when executed by processing circuitry cause the processing circuitry to perform the method of any one of embodiments described above.

In another aspect, there is provided a network node. The network node is configured to obtain information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The network node is further configured to transmit the information towards a deterministic network, DetNet, controller.

In another aspect, there is provided a network node. The network node is configured to generate information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The network node is further configured to transmit the information towards a session management function, SMF.

In another aspect, there is provided a network node. The network node is configured to obtain information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The network node is further configured to transmit the information towards a policy control function, PCF.

In another aspect, there is provided a network node. The network node is configured to obtain information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. The network node is further configured to transmit the information towards a time sensitive communication and time synchronization function, TSCTSF.

In another aspect, there is provided a deterministic network, DetNet, controller. The DetNet controller is configured to receive information comprising port information and/or node information, wherein the information was transmitted by a network node, the port information includes at least one port identifier identifying at least one port which is assigned to a Packet Data Unit, PDU, session and/or which is associated with a user plane function, UPF, and the node information includes a node identifier identifying the UPF. The DetNet controller is further configured to, using the received information, generate topology information indicating topology of the logical network node.

In another aspect, there is provided an apparatus comprising a memory; and processing circuitry coupled to the memory, wherein the apparatus is configured to perform the method of any one of embodiments described above.

Embodiments of this disclosure enable the 3 GPP system to participate in an IP network that is controlled by a central controller by providing information to help the central controller to establish network topology. This is especially useful given that the ports corresponding to the PDU Sessions may dynamically change due to the establishment and removal of the PDU Sessions.

### BRIEF DESCRIPTION OF THE DRAWINGS

The accompanying drawings, which are incorporated herein and form part of the specification, illustrate various embodiments.

FIG. 1 shows a system according to some embodiments.

FIG. 2 shows an environment in which the system according to some embodiments is implemented.

FIG. 3 shows a process according to some embodiments.

FIG. 4 shows a process according to some embodiments.

FIG. 5 shows a process according to some embodiments.

FIG. 6 shows a process according to some embodiments.

FIG. 7 shows a process according to some embodiments.

FIG. 8 shows a process according to some embodiments.

FIG. 9 shows a process according to some embodiments.

FIG. 10 shows an apparatus according to some embodiments.

FIG. 11 shows an apparatus according to some embodiments.

### DETAILED DESCRIPTION

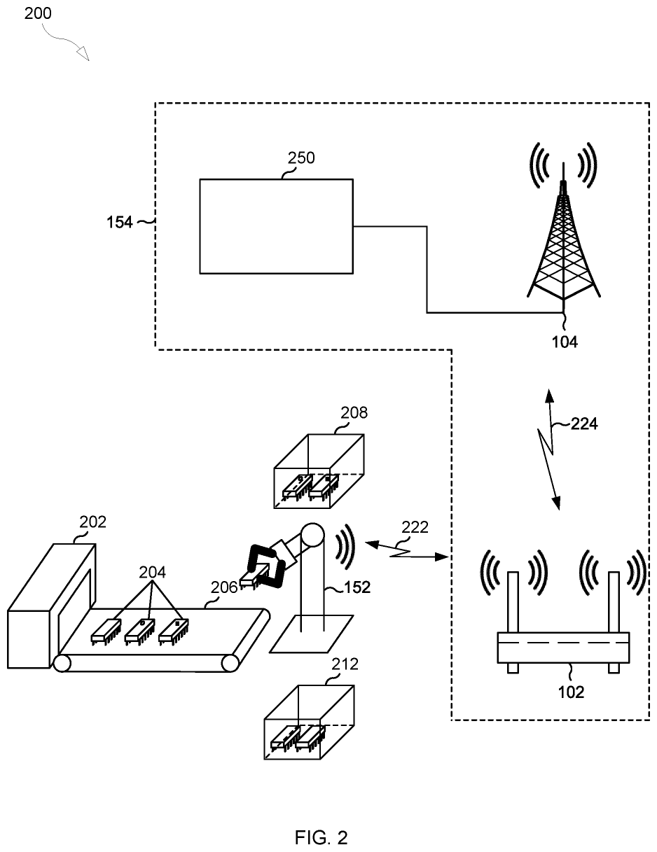

FIG. 2 shows a simplified exemplary environment 200 according to some embodiments. In the environment 200, there are provided storages 202, 208, and 212, a conveyor belt 206, and a robot 152. As shown in FIG. 2, items (e.g., computer chips) stored in the storage 202 are moved from the storage 202 to the conveyor belt 206. The robot 152 is configured to classify items 204 on the conveyor belt 206 into defective items and non-defective items, and place them into the storage 208 or the storage 212 according to the classification. The storage 208 is for collecting defective items and the storage 212 is for collecting non-defective items.

The robot 152 is configured to be controlled by commands 222 transmitted by a 3GPP system 154 (e.g., a fifth generation (5G) system). More specifically, the 3GPP system 154 may include a wireless router which may be configured to transmit commands 222 towards the robot 152 via a wireless network (e.g., a Wi-Fi network or a 3GPP network). The wireless router 102 is configured to transmit commands 222 based on signals 224 received from a network node 104 (e.g., a base station). The network node 104 is configured to transmit the signals 224 via a network (e.g., a 3GPP network such as a 5G network) based on signals generated from a plurality of functions (e.g., nodes) 250 included in the 3GPP system 154.

In the environment 200, it is important to transmit and/or receive the commands 222 and/or the signals 224 without much delay because if there is a substantial delay in transmitting and/or receiving the commands 222 and/or the signals 224, the robot 12 may not be able to classify the items 204 on time, and thus the items 204 may not be classified correctly or may not be classified at all.

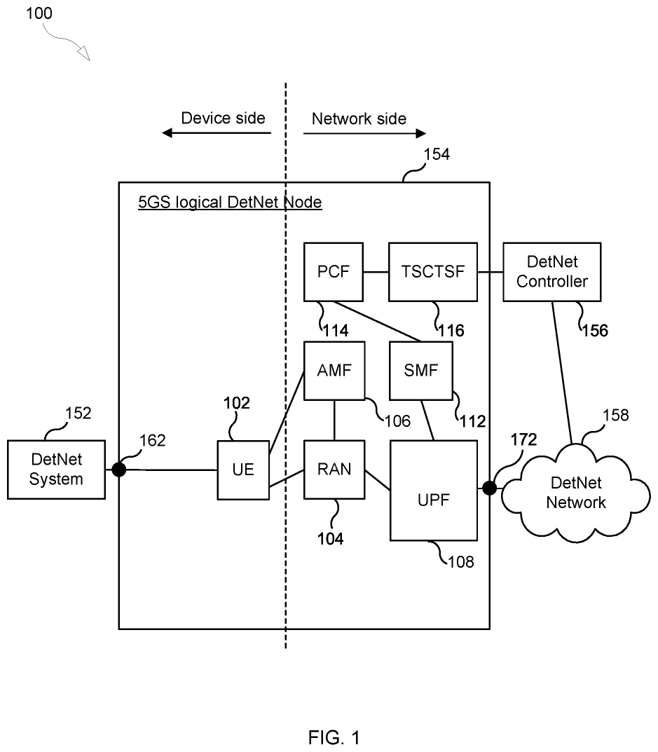

Thus, as shown in FIG. 1, according to some embodiments of this disclosure, the 3GPP system 154 (herein after, “5GS” for simplification purpose) may be integrated into a DetNet architecture 100. As discussed above, DetNet networks are capable of providing guaranteed latency on a per-deterministic-flow basis, and the data traffic of each deterministic flow is delivered within a guaranteed bounded latency and low delay variation constraint.

As shown in FIG. 1, the DetNet architecture 100 may comprise a DetNet system 152, a DetNet node 154, a DetNet controller 156, and a DetNet network 158. The DetNet system 152 is a device of which operations depend on networks provided by the DetNet node 154. One example of the DetNet system 152 is the robot 152 shown in FIG. 2. The DetNet system 152 is coupled to the DetNet node 154 via a port 162.

According to some embodiments, as shown in FIG. 1, 5GS may serve as the DetNet node 154. The 5GS may include a user equipment (UE) 102, a radio access network (RAN) 104, an access and mobility function (AMF) 106, a user plane function (UPF) 108, a session management function (SMF) 112, a policy control function (PCF) 114, and a time sensitive communication and time synchronization function, TSCTSF 116.

The number of entities (e.g., the DetNet system 152, the UE 102, the RAN 104, . . . ) is provided in FIG. 1 for illustration purpose only and does not limit the embodiments of this disclosure in any way. For example, in some embodiments, a plurality of DetNet systems 152 is included in the DetNet architecture 100. In such embodiments, the DetNet architecture 100 may also include a plurality of UEs 102 each of which is connected to each of the plurality of DetNet systems 152. Also, in such embodiments, the plurality of UEs 102 may be connected to the same RAN or different RANs and to the same UPF or different UPFs.

The TSCTSF 116 may be coupled to the DetNet controller 156 which is coupled to the DetNet network 158, and the UPF 108 may be coupled to the DetNet network 158 via a port 172.

As discussed above, in order to achieve a better integration of the 5GS into the DetNet architecture 100, it may be needed for the DetNet controller 156 to know about topology of the 5GS. Thus, it may be desirable for the 5GS to provide topology information to the DetNet controller 156. In this disclosure, topology information means any information that can be used to determine at least a part of topology of a network and/or a system (e.g., the 5GS 154).

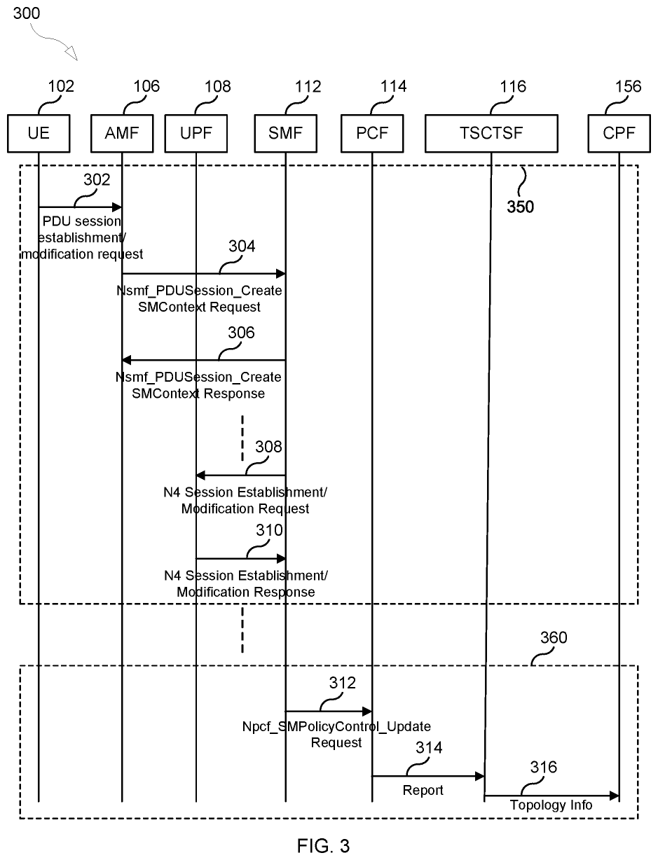

FIG. 3 shows an exemplary process 300 for providing the topology information to DetNet controller 156 (a.k.a., DET controller plane function (CPF) according to some embodiments. Here, the topology information is for the device side port (e.g., 162) of the 5GS 154. For simplification purpose, not all messages exchanged among the entities (e.g., UE 102, AMF 106, . . . , etc.) are shown in FIG. 3.

As shown in FIG. 3, process 300 corresponds to a PDU session establishment (or modification) procedure 350 and a SMF initiated SM policy association modification procedure 360. The process 300 may begin with UE 102 transmitting towards AMF 106 a PDU session establishment (or modification) request 302.

After receiving PDU session establishment (or modification) request 302, AMF 106 transmits towards SMF 112 Nsmf_PDUSession_CreateSMContext Request 304 (or Nsmf_PDUSession_UpdateSMContext Request). In response to receiving request 304, SMF 112 transmits towards AMF 106 Nsmf_PDUSession_CreateSMContext Response 306 (or Nsmf_PDUSession_UpdateSMContext Response).

After receiving request 304 and/or transmitting response 306, SMF 112 transmits towards UPF 108 N4 session establishment/modification request 308. In some embodiments, request 308 may correspond to a request for providing the topology information. The transmission of request 308 may be based on configuration for a given data network name (DNN) associated with a given data network and single network slice selection assistance information (S-NSSAI) identifying a network slice.

In such embodiments, as a result of receiving the request 308, UPF 108 may transmit towards SMF 112 the requested topology information. More specifically, as a result of receiving request 308, UPF 108 may transmit towards SMF 112 N4 session establishment/modification response 310 which includes the requested topology information.

As discussed above, in this disclosure, topology information means any information that can be used to determine at least a part of topology of a network and/or a system (e.g., the 5GS 154).

The topology information may include port (a.k.a., “interface”) information. The port information may be reported based on the YANG model in RFC 8344—“A YANG Data Model for IP Management”—, which is in turn based on RFC 8343—“A YANG Data Model for Interface Management.”

The model may include any one or a combination of: (1) a port identifier (e.g., if-Index and name) to identify a port (e.g., 162) that is on the device side of the 5GS 154 and is associated with a given PDU session in the 5GS; (2) a type of the identified port, which identifies whether the port is a 3GPP port on the device side of the 5GS 154 or a fixed port on the network side of the 5GS 154 (here, the type is the 3GPP port because the port is on the device side); (3) an IP address of the UE 102; (4) when available, neighbor IP addresses and link layer address, which may be based on ARP or IPv6 neighbor discovery (this may be reported also in case neighbor IP address information is collected in other ways); and (5) any other port information such as whether the port is enabled or not, statistics related to the usage of the port (e.g., the amount of traffic that went through the port, how long the port was operational, etc.), etc.

In some embodiments, for each PDU session, UPF 108 may generate the port identifier (a.k.a., “port number”) which identifies a particular port (e.g., 162, 164, or 166) on the device side of UPF 108 and is unique to UPF 108 in a given network instance, similarly as in the release 17 case. The port identifier can be used as the if-index. Based on the if-Index, the name maybe generated, e.g., by using the if-Index as a string and possibly adding to the string a substring prefix or postfix based on configuration. The if-Index and the name of the port (i.e., the name of the interface) may contain essentially the same information, but both can be provided to the DetNet controller 156, since the name is used as the key in the YANG model, while if-Index is usually considered as the basis for interface management of IP nodes.

In some embodiments, the port information may include information of more than one ports. For example, the YANG model described above may be provided for each of a plurality of ports on the device side of UPF 108.

Instead of or in addition to the port information, the topology information may also include a node identifier identifying the 5GS 154. For example, the topology information may include a user plane node ID which identifies UPF 108. There may be different ways of constructing the user plane node ID. In one example, the user plane node ID can be constructed based on an IP address of UPF 108. In another example, the user plane node ID may be constructed based on any one or a combination of the IP address of UPF 108, a data network name (DNN) associated with a given data network, single network slice selection assistance information (S-NSSAI) identifying a network slice, or network instance known at UPF 108.

In some embodiments, the user plane node ID may be based on a YANG parameter of host type as defined in RFC 6021, “Common YANG Data Types,” which can be either an IP address (e.g., a dummy IP address—i.e., a sequence of numbers that has the same format as an IP address but is not a network address used for data traffic at a given node) or a domain name associated with UPF 108. With this approach, the host (i.e., the 5GS 154) is identified towards the DetNet controller, and the host identification is also provided together with the configuration.

Alternatively, the DetNet node (i.e., the 5GS) 154 may be identified by an IP address terminating the interface on the TSCTSF towards the DetNet controller. But, in such embodiments, the IP address needs to be different for each logical DetNet node (i.e., each of different 5GSs) which is on a per UPF granularity.

It may be useful for DetNet controller 156 to be able to identify that DetNet node 154 is a 3GPP defined 5GS system, rather than a router with fixed interfaces only. This identification can be useful for DetNet controller 156 to consider for determining or evaluating quality of service (“QoS”) that can be provided for a flow. There are different ways for DetNet controller 156 to make the identification.

For example, the port type included in the topology information may indicate that the port is a 3GPP port. DetNet controller 156 may construe a node having a 3GPP interface (i.e., port) as a 5GS. Alternatively or additionally, if DetNet node 154 is identified by a domain name, the domain name may include a substring that identify the node as a 5GS node. Alternatively or additionally, DetNet controller 156 may be pre-configured with a list or a range of node addresses or names that correspond to 5GS nodes.

When available, 5GS (DetNet node) 154 may optionally provide additional topology information based on the YANG models in RFC8345 or RFC8795. Additionally, 5GS 154 may also report to DetNet controller 156 network characteristics such as expected packet delay. This may be provided based on pre-configuration or based on measurement reports. In some embodiments, the packet delay may be reported separately, depending on whether the packet is forwarded between a network side port and a device side port, between two network side ports, or between two device side ports. For such packet delay, new YANG parameters may be defined and used.

The reporting of the topology information from 5GS node 154 to DetNet controller 156 may be performed using YANG data models that can be carried using Netconf (RFC 6241) or Restconf (RFC 8040). Given that DetNet is an IETF solution that can be used for a number of link layer technologies, IETF protocols are assumed at DetNet controller 156.

In the embodiments shown in FIG. 1, a network exposure function (NEF) is not disposed between DetNet controller 156 and TSCTSF 116 since DetNet controller 156 is assumed to be trusted by a network operator, as it can influence the QoS of traffic flows, which requires operator trust relationship. It is noted that the NEF cannot intercept the messages carried over Netconf or Restconf anyways.

However, in some other embodiments, a NEF may be disposed between DetNet controller 156 and TSCTSF 116 and may serve as an intermediate entity receiving the topology information from TSCTSF 116 and forwarding the topology information towards DetNet controller 156.

For the device-side port (i.e., the port corresponding to PDU sessions), some of the topology information (e.g., the port information and the IP address of UE 102) may be provided to TSCTSF 116 without requiring a port management information container (PMIC) from UE 102. It can be useful to be able to use DetNet even without having to require a PMIC, which makes the DetNet solution easier to deploy (but using a PMIC is not excluded, e.g., for time synch purposes). Other topology information (such as the list of IP neighbors of a given device) may be provided as a part of the PMIC. Based on configuration in PCF 114 for a given DNN, S-NSSAI, TSCTSF may be notified of the topology information.

After obtaining the topology information, SMF 112 may provide the topology information towards PCF 114 as a part of SMF initiated SM policy association modification procedure 360. More specifically, in one example, SMF 112 may transmit towards PCF 114 Npcf_SMPolicyControl_Update Request 312 which includes the topology information (e.g., the port identifier(s) and/or the user-plane ID). In some embodiments, in addition to the port identifier(s) and/or the user-plane ID, the topology information may also include the IP address of UE 102. More specifically, SMF 112 may include the IP address of UE 102 (or equivalently the IP address of DetNet system 152) in the topology information. The transmission of request 312 may be based on configuration for a given DNN and S-NSSAI.

Upon receiving the request 312, as a part of SMF initiated SM policy association modification procedure 360, PCF 114 may transmit towards TSCTSF 116 a report message 314 that includes the topology information. After receiving report message 314, TSCTSF 116 may transmit towards CPF 156 topology information message 316. The detailed signaling of message 316 may depend on the actual Internet Engineering Task Force (IETF) protocol used between TSCTSF 116 and CPF 156. Topology information message 316 may be transmitted from TSCTSF 116 towards CPF 156 upon CPF 156 requesting TSCTSF 116 to transmit the topology information. Alternatively, Topology information message 316 may be transmitted from TSCTSF 116 towards CPF 156 immediately based on a notification mechanism of TSCTSF 116. or upon a notification mechanism of TSCTSF 116.

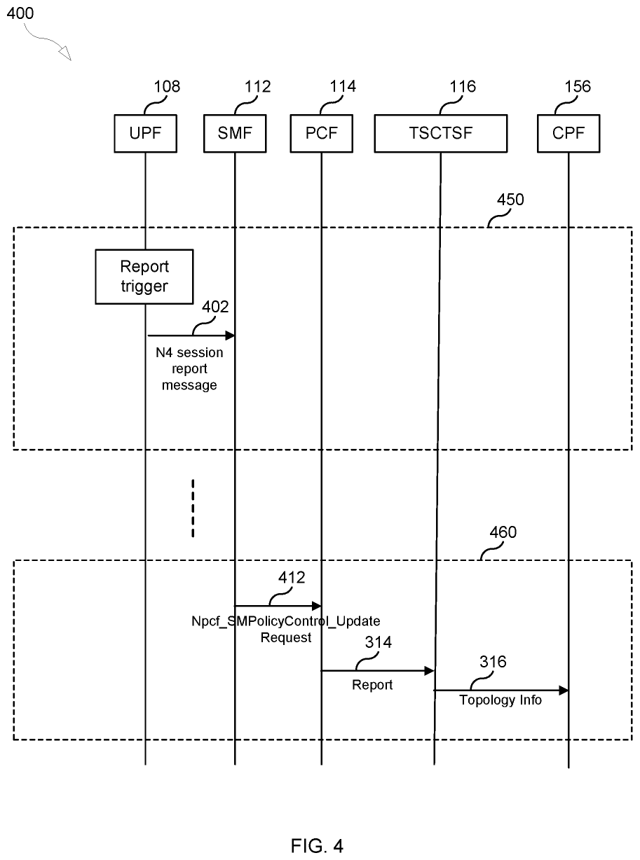

FIG. 4 shows another exemplary process 400 for providing the topology information to DetNet controller (i.e., CPF) 156, according to some embodiments. Here, the topology information is for the network side port (e.g., 172) of the 5GS 154. Like FIG. 3, for simplification purpose, not all messages exchanged between the entities (e.g., UE 102, UPF 108, PCF 114, . . . , etc.) are shown in FIG. 4.

As shown in FIG. 4, process 400 corresponds to an N4 session level reporting procedure 450 and a SMF initiated SM policy association modification procedure 460. Process 400 may begin with UPF 108 determining that an event related to an N4 session for a given PDU session should be reported. The triggers of the reporting may be configured in UPF 108 by SMF 112 during the N4 session establishment/modification procedure. The triggers of the reporting may include collection of usage information and/or detection of start or stop of traffic.

After determining that an event should be reported, UPF 108 may transmit towards SMF 112 an N4 session report message 402. In some embodiments, N4 session report message 402 may include the topology information.

The topology information may include port (a.k.a., “interface”) information. The port/interface information may be generated and/or reported based on the YANG model in RFC 8344—“A YANG Data Model for IP Management”—, which is in turn based on RFC 8343—“A YANG Data Model for Interface Management.”

The model may include any one or a combination of: (1) a port identifier (e.g., if-Index and name) to identify a port (e.g., port 172 shown in FIG. 1) that is on the network side of the 5GS 154 and is unique to UPF 108; (2) a type of the identified port, which identifies whether the port is a 3GPP port on the device side of the 5GS 154 or a fixed port on the network side of the 5GS 154; (3) an IP address and subnet associated with UPF 108; (4) when available, neighbor IP addresses and link layer address, which may be based on ARP or IPV6 neighbor discovery (this may be reported also in case neighbor IP address information is collected in other ways); and (5) any other port information such as whether the port is enabled or not, statistics related to the usage of the port (e.g., the amount of traffic that went through the port, how long the port was operational, etc.), etc.

In some embodiments, UPF 108 may generate the port identifier (a.k.a., “port number”) identifying a particular port (e.g., 172) on the network side of UPF 108. The port identifier can be used as the if-index. Based on the if-Index, the name maybe generated, e.g., by using the if-Index as a string and possibly adding to the string a substring prefix or postfix based on configuration. The if-Index and the name of the port may contain essentially the same information, but both can be provided to the DetNet controller 156, since the name is used as the key in the YANG model, while if-Index is usually considered as the basis for interface management of IP nodes.

In some embodiments, the port information may include information of more than one ports. For example, the YANG model described above may be provided for each of a plurality of ports (e.g., 172) on the network side of UPF 108.

Instead of or in addition to the port information, the topology information may also include a node identifier identifying the 5GS 154. For example, the topology information may include a user plane node ID which identifies UPF 108. There may be different ways of constructing the user plane node ID. In one example, the user plane node ID can be constructed based on an IP address of UPF 108. In another example, the user plane node ID may be constructed based on any one or a combination of the IP address of UPF 108, a data network name, single network slice selection assistance information (S-NSSAI), or network instance known at UPF 108.

TSCTSF 116 uses the user plane node ID provided by UPF 108 and may optionally update it as needed (e.g., convert it to a domain name string, or map it to an IP address used for a network management protocol), to determine the host (i.e., the 5GS 154) identification used for the given 5GS node.

In some embodiments, the user plane node ID may be based on a YANG parameter of host type as defined in RFC 6021, “Common YANG Data Types,” which can be either an IP address (e.g., a dummy IP address) or a domain name associated with UPF 108. With this approach, the host (i.e., the 5GS 154) is identified towards the

DetNet controller, and the host identification is also provided together with the configuration.

Alternatively, the DetNet node (i.e., the 5GS) 154 may be identified by an IP address terminating the interface on the TSCTSF towards the DetNet controller. But, in such embodiments, the IP address needs to be different for each logical DetNet node (i.e., each of different 5GSs) which is on a per UPF granularity.

In some embodiments, some of the above information included in the topology information (e.g., the IP address, the subnet, and neighbor information such as a list of neighbor IP addresses) may be carried in a port management information container (PMIC). In such embodiments, the PMIC may be transmitted with the port identifier and the user plane ID.

It may be useful for DetNet controller 156 to be able to identify that DetNet node 154 is a 3GPP defined 5GS system, rather than a router with fixed interfaces only. This identification can be useful for DetNet controller 156 to consider for determining or evaluating quality of service (“QoS”) that can be provided for a flow. There are different ways for DetNet controller 156 to make the identification.

For example, the port type included in the topology information may indicate that the port is a 3GPP port. DetNet controller 156 may construe a node having a 3GPP interface (i.e., port) as a 5GS. Alternatively or additionally, if DetNet node 154 is identified by a domain name, the domain name may include a substring that identify the node as a 5GS node. Alternatively or additionally, DetNet controller 156 may be pre-configured with a list or a range of node addresses or names that correspond to 5GS nodes.

When available, 5GS (DetNet node) 154 may optionally provide additional topology information based on the YANG models in RFC8345 or RFC8795. Additionally, 5GS 154 may also report to DetNet controller 156 network characteristics such as expected packet delay. This may be provided based on pre-configuration or based on measurement reports. In some embodiments, the packet delay may be reported separately, depending on whether the packet is forwarded between a network side port and a device side port, between two network side ports, or between two device side ports. For such packet delay, new YANG parameters may be defined and used.

The reporting of the topology information from 5GS node 154 to DetNet controller 156 may be performed using YANG data models that can be carried using Netconf (RFC 6241) or Restconf (RFC 8040). Given that DetNet is an IETF solution that can be used for a number of link layer technologies, IETF protocols are assumed at DetNet controller 156.

In the embodiments shown in FIG. 1, a network exposure function (NEF) is not disposed between DetNet controller 156 and TSCTSF 116 since DetNet controller 156 is assumed to be trusted by a network operator, as it can influence the QoS of traffic flows, which requires operator trust relationship. It is noted that the NEF cannot intercept the messages carried over Netconf or Restconf anyways.

However, in some other embodiments, a NEF may be disposed between DetNet controller 156 and TSCTSF 116 and may serve as an intermediate entity receiving the topology information from TSCTSF 116 and forwarding the topology information towards DetNet controller 156.

After receiving the topology information, SMF 112 may transmit the topology information towards PCF 114 as a part of SMF initiated SM policy association modification procedure 460. More specifically, in one example, SMF 112 may transmit towards PCF 114 Npcf_SMPolicyControl_Update Request 412 which includes the topology information (e.g., the port identifier and/or the user-plane ID). The transmission of request 412 may be based on configuration for a given DNN and S-NSSAI.

Upon receiving the request 412, as a part of SMF initiated SM policy association modification

procedure 460, PCF 114 may transmit towards TSCTSF 116 a report message 414 that includes the topology information. After receiving report message 414, TSCTSF 116 may transmit towards CPF 156 topology information message 416. The detailed signaling of message 416 may depend on the actual Internet Engineering Task Force (IETF) protocol used between TSCTSF 116 and CPF 156. Topology information message 416 may be transmitted from TSCTSF 116 towards CPF 156 upon CPF 156 requesting TSCTSF 116 to transmit the topology information. Alternatively, Topology information message 416 may be transmitted from TSCTSF 116 towards CPF 156 immediately based on a notification mechanism of TSCTSF 116.

The process for providing the topology information to the DetNet controller 156 is not limited to process 300 and 400, and other signalling process can be used for providing the topology information.

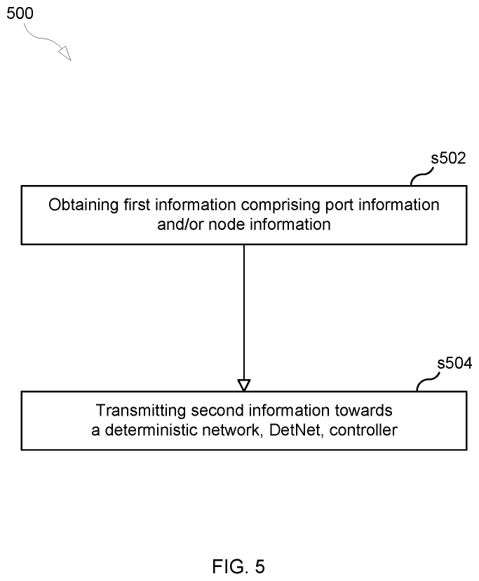

FIG. 5 shows a process 500 performed by a network node, according to some embodiments. Process 500 may begin with step s502. Step s502 comprises obtaining first information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. Step s504 comprises transmitting towards a deterministic network, DetNet, controller second information generated based on the first information.

In some embodiments, the first information comprises the node information, and the second information comprises information determined based on the node information.

In some embodiments, the information determined based on the node information is a node identifier identifying a 5G system, 5GS, node.

In some embodiments, the network node is a time sensitive communication and time synchronization function, TSCTSF included in the 5GS node. In some embodiments, the second information comprises a node identifier identifying the 5GS node, and the node identifier included in the second information is an IP address for signaling between the network node and the DetNet controller.

In some embodiments, the first information comprises the port information, and the second information comprises information determined based on the port information.

In some embodiments, the information determined based on the port information comprises at least one interface identifier, and said at least one interface identifier is determined based on said at least one port identifier.

In some embodiments, the information determined based on the port information comprises at least one interface name, and said at least one interface name is determined based on said at least one port identifier.

In some embodiments, the network node is a time sensitive communication and time synchronization function, TSCTSF.

In some embodiments, the port information further includes any one or more of: at least one port type indicator indicating a type of said at least one port, at least one IP address of the UPF, an IP address of a user equipment, UE, coupled to the UPF, one or more neighboring IP addresses of the UPF, a subnet address associated with the UPF, or usage data regarding usage of the port.

In some embodiments, said at least one IP address of the UPF, the IP address of the UE, and/or said one or more neighboring IP addresses of the UPF are included in a port management information container, PMIC, and said at least one port identifier and/or the node identifier is not included in the PMIC.

In some embodiments, said at least one port type indicator indicates whether the type of said at least one port is a 3GPP port or a fixed port.

In some embodiments, the usage data indicates an amount of traffic passed through the port and/or a time interval during which the port was operational.

In some embodiments, the node identifier is generated based on any one or a combination of an IP address associated with the UPF, a data network name (DNN) associated with a given data network, or single network slice selection assistance information (S-NSSAI) identifying a network slice.

In some embodiments, the node information includes any one or more of: a domain name associated with the UPF, an IP address identifying the UPF, a type indicator indicating whether a network system including the network node is a 3GPP defined system or a router having fixed interfaces, or network information indicating characteristics of a network provided by the network system including the network node.

In some embodiments, the network system is a fifth generation, 5G, system, 5GS.

In some embodiments, the second information is transmitted by the network node towards the DetNet controller via a network exposure function, NEF.

In some embodiments, said at least one port identifier comprises at least one port index of said at least one port and at least one port name of said at least one port, and said at least one port name is generated by adding a prefix or a postfix to said at least one port index.

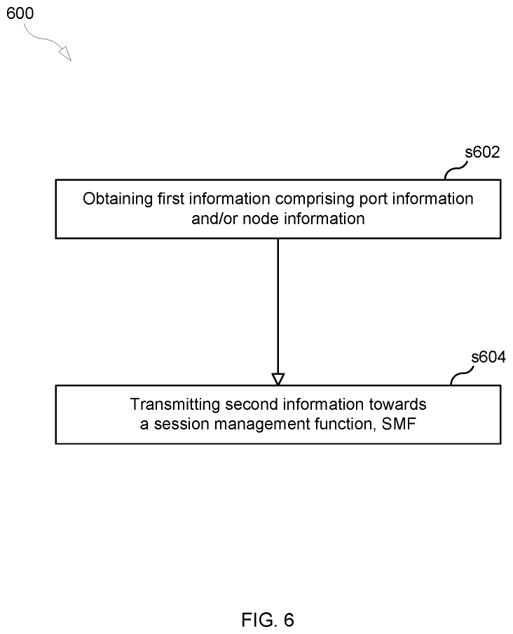

FIG. 6 shows a process 600 performed by a network node. The process may begin with step s602. Step s602 comprises obtaining first information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. Step s604 comprises transmitting towards a session management function, SMF second information corresponding to the first information.

In some embodiments, the network node is the UPF.

In some embodiments, the method further comprises receiving a message triggering the UPF to generate said at least one port identifier, wherein the message was sent by the SMF; and as a result of receiving the message, generating said at least one port identifier.

In some embodiments, the message is an N4 session establishment request or an N4 session modification request.

In some embodiments, transmitting the second information comprises transmitting an N4 session establishment response or an N4 session modification response, and the N4 session establishment response or then N4 session modification response comprises the second information.

In some embodiments, the port information further includes any one or more of: at least one port type indicator indicating a type of said at least one port, at least one IP address of the UPF, an IP address of a user equipment, UE, coupled to the UPF, one or more neighboring IP addresses of the UPF, a subnet address associated with the UPF, or usage data regarding usage of the port.

In some embodiments, said at least one IP address of the UPF, the IP address of the UE, and/or said one or more neighboring IP addresses of the UPF are included in a port management information container, PMIC, and said at least one port identifier and/or the node identifier is not included in the PMIC.

In some embodiments, said at least one port type indicator indicates whether the type of said at least one port is a 3GPP port or a fixed port.

In some embodiments, the usage data indicates an amount of traffic passed through the port and/or a time interval during which the port was operational.

In some embodiments, the node identifier is generated based on any one or a combination of an IP address associated with the UPF, a data network name (DNN) associated with a given data network, or single network slice selection assistance information (S-NSSAI) identifying a network slice.

In some embodiments, the node information includes any one or more of: a domain name associated with the UPF, an IP address identifying the UPF, a type indicator indicating whether a network system including the network node is a 3GPP defined system or a router having fixed interfaces, or network information indicating characteristics of a network provided by the network system including the network node.

In some embodiments, the network system is a fifth generation, 5G, system, 5GS.

In some embodiments, said at least one port identifier comprises at least one port index of said at least one port and at least one port name of said at least one port, and said at least one port name is generated by adding a prefix or a postfix to said at least one port index.

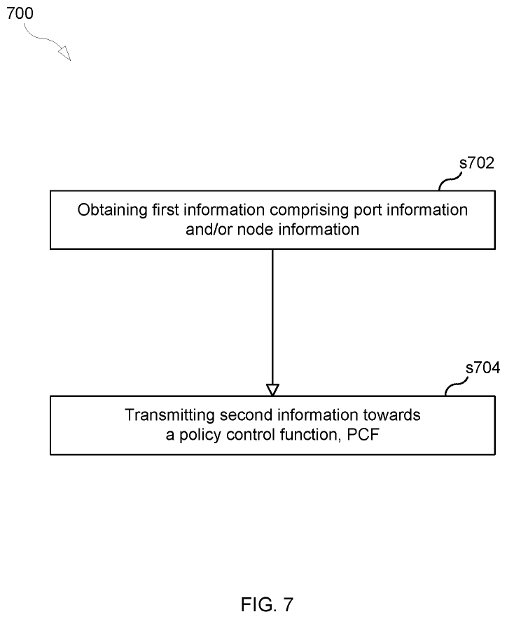

FIG. 7 shows a process performed by a network node. Process 700 may begin with step s702. Step s702 comprises obtaining first information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. Step s704 comprises transmitting towards a policy control function, PCF, second information corresponding to the first information.

In some embodiments, the network node is a session management function, SMF.

In some embodiments, the method further comprises transmitting towards the UPF a message triggering the UPF to generate said at least one port identifier; and as a result of transmitting the message, receiving the first information, wherein the first information was transmitted by the UPF.

In some embodiments, the message is an N4 session establishment request or an N4 session modification request.

In some embodiments, receiving the first information comprises receiving an N4 session establishment response or an N4 session modification response, and the N4 session establishment response or then N4 session modification response comprises the first information.

In some embodiments, the port information further includes any one or more of: at least one port type indicator indicating a type of said at least one port, at least one IP address of the UPF, an IP address of a user equipment, UE, coupled to the UPF, one or more neighboring IP addresses of the UPF, a subnet address associated with the UPF, or usage data regarding usage of the port.

In some embodiments, said at least one IP address of the UPF, the IP address of the UE, and/or said one or more neighboring IP addresses of the UPF are included in a port management information container, PMIC, and said at least one port identifier and/or the node identifier is not included in the PMIC.

In some embodiments, said at least one port type indicator indicates whether the type of said at least one port is a 3GPP port or a fixed port.

In some embodiments, the usage data indicates an amount of traffic passed through the port and/or a time interval during which the port was operational.

In some embodiments, the node identifier is generated based on any one or a combination of an IP address associated with the UPF, a data network name (DNN) associated with a given data network, or single network slice selection assistance information (S-NSSAI) identifying a network slice.

In some embodiments, the node information includes any one or more of: a domain name associated with the UPF, an IP address identifying the UPF, a type indicator indicating whether a network system including the network node is a 3GPP defined system or a router having fixed interfaces, or network information indicating characteristics of a network provided by the network system including the network node.

In some embodiments, the network system is a fifth generation, 5G, system, 5GS.

In some embodiments, said at least one port identifier comprises at least one port index of said at least one port and at least one port name of said at least one port, and said at least one port name is generated by adding a prefix or a postfix to said at least one port index.

In some embodiments, transmitting the second information towards the PCF comprises transmitting an Npcf_SMPolicyControl_Update request.

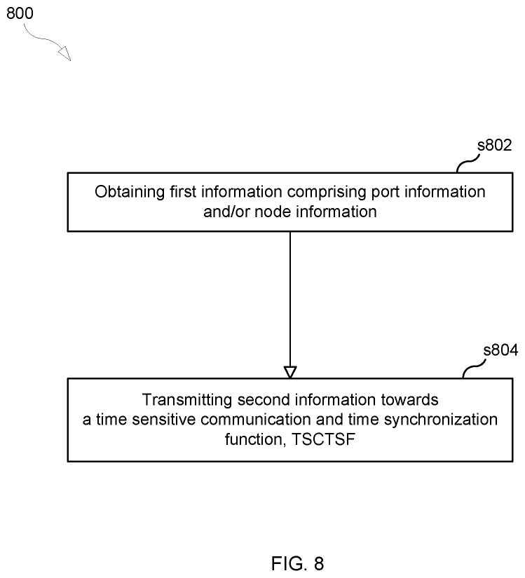

FIG. 8 shows a process 800 performed by a network node. Process 800 may begin with step s802. Step s802 comprises obtaining first information comprising port information and/or node information, wherein the port information includes at least one port identifier identifying at least one port which is assigned to a Packet Data Unit, PDU, session and/or which is associated with a user plane function, UPF, and the node information includes a node identifier identifying the UPF. Step s804 comprises transmitting towards a time sensitive communication and time synchronization function, TSCTSF, second information corresponding to the first information.

In some embodiments, the network node is a policy control function.

In some embodiments, the port information further includes any one or more of: at least one port type indicator indicating a type of said at least one port, at least one IP address of the UPF, an IP address of a user equipment, UE, coupled to the UPF, one or more neighboring IP addresses of the UPF, a subnet address associated with the UPF, or usage data regarding usage of the port.

In some embodiments, said at least one IP address of the UPF, the IP address of the UE, and/or said one or more neighboring IP addresses of the UPF are included in a port management information container, PMIC, and said at least one port identifier and/or the node identifier is not included in the PMIC.

In some embodiments, said at least one port type indicator indicates whether the type of said at least one port is a 3GPP port or a fixed port.

In some embodiments, the usage data indicates an amount of traffic passed through the port and/or a time interval during which the port was operational.

In some embodiments, the node identifier is generated based on any one or a combination of an IP address associated with the UPF, a data network name (DNN) associated with a given data network, or single network slice selection assistance information (S-NSSAI) identifying a network slice.

In some embodiments, the node information includes any one or more of: a domain name associated with the UPF, an IP address identifying the UPF, a type indicator indicating whether a network system including the network node is a 3GPP defined system or a router having fixed interfaces, or network information indicating characteristics of a network provided by the network system including the network node.

In some embodiments, the network system is a fifth generation, 5G, system, 5GS.

In some embodiments, said at least one port identifier comprises at least one port index of said at least one port and at least one port name of said at least one port, and said at least one port name is generated by adding a prefix or a postfix to said at least one port index.

In some embodiments, obtaining the first information comprises receiving an Npcf_SMPolicyControl_Update request, and the Npcf_SMPolicyControl_Update request was transmitted by the SMF.

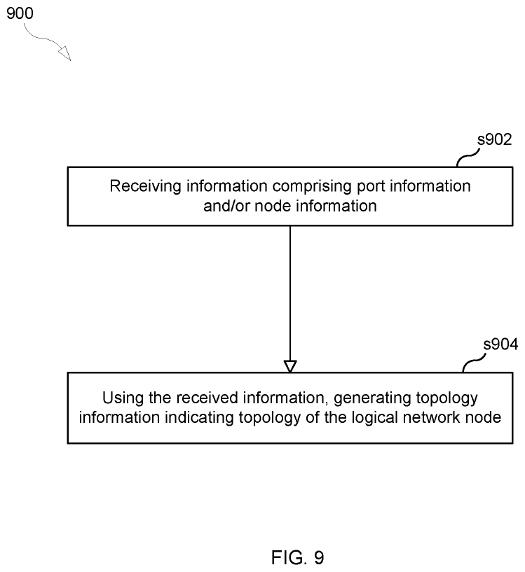

FIG. 9 shows a process 900 performed by a deterministic network, DetNet, controller. Process 900 may begin with step s902. Step s902 comprises receiving information comprising port information and/or node information, wherein the information was transmitted by a network node, the port information includes at least one port identifier identifying at least one port which is assigned to a Packet Data Unit, PDU, session and/or which is associated with a user plane function, UPF, and the node information includes a node identifier identifying the UPF. Step s904 comprises, using the received information, generating topology information indicating topology of the logical network node.

In some embodiments, the network node is a time sensitive communication and time synchronization function, TSCTSF or a network exposure function, NEF.

In some embodiments, the port information further includes any one or more of: at least one port type indicator indicating a type of said at least one port, at least one IP address of the UPF, an IP address of a user equipment, UE, coupled to the UPF, one or more neighboring IP addresses of the UPF, a subnet address associated with the UPF, or usage data regarding usage of the port.

In some embodiments, said at least one IP address of the UPF, the IP address of the UE, and/or said one or more neighboring IP addresses of the UPF are included in a port management information container, PMIC, and said at least one port identifier and/or the node identifier is not included in the PMIC.

In some embodiments, said at least one port type indicator indicates whether the type of said at least one port is a 3GPP port or a fixed port.

In some embodiments, the usage data indicates an amount of traffic passed through the port and/or a time interval during which the port was operational.

In some embodiments, the node identifier is generated based on any one or a combination of an IP address associated with the UPF, a data network name (DNN) associated with a given data network, or single network slice selection assistance information (S-NSSAI) identifying a network slice.

In some embodiments, the node information includes any one or more of: a domain name associated with the UPF, an IP address identifying the UPF, a type indicator indicating whether a network system including the TSCTSF is a 3GPP defined system or a router having fixed interfaces, or network information indicating characteristics of a network provided by the network system including the TSCTSF.

In some embodiments, the network system is a fifth generation, 5G, system, 5GS.

In some embodiments, said at least one port identifier comprises at least one port index of said at least one port and at least one port name of said at least one port, and said at least one port name is generated by adding a prefix or a postfix to said at least one port index.

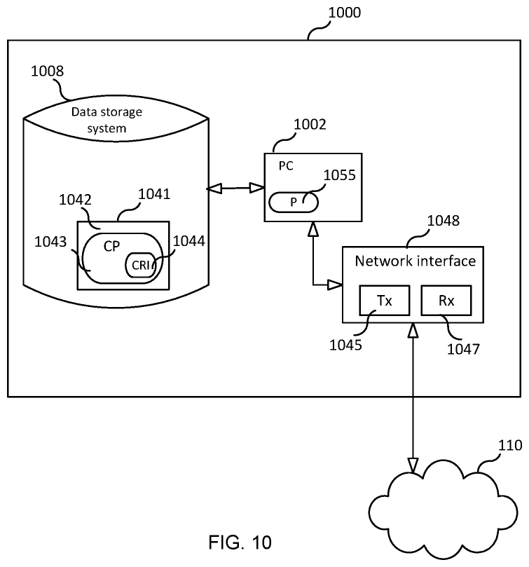

FIG. 10 is a block diagram of an apparatus 1000, according to some embodiments, for implementing any of the entities (UE 102, RAN 104, AMF 106, . . . ) shown in FIG. 1. As shown in FIG. 10, apparatus 1000 may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1000 may be a distributed computing apparatus); a network interface 1048 comprising a transmitter (Tx) 1045 and a receiver (Rx) 1047 for enabling apparatus 1000 to transmit data to and receive data from other nodes connected to a network 110 (e.g., an Internet Protocol (IP) network) to which network interface 1048 is connected (directly or indirectly) (e.g., network interface 1048 may be wirelessly connected to the network 110, in which case network interface 1048 is connected to an antenna arrangement); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes apparatus 1000 to perform steps described herein (e.g., steps described herein with reference to the flow charts). In other embodiments, apparatus 1000 may be configured to perform steps described herein without the need for code. That is, for example, PC 1002 may consist merely of one or more ASICs. Hence, the features of the embodiments described herein may be implemented in hardware and/or software.

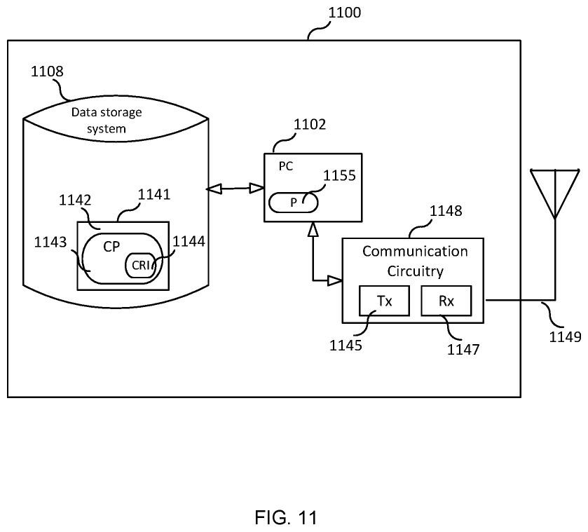

FIG. 11 is a block diagram of DetNet system 152, according to some embodiments. As shown in FIG. 11, DetNet system 152 may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling DetNet system 152 to transmit data and receive data (e.g., wirelessly transmit/receive data); and a local storage unit (a.k.a., “data storage system”) 1108, which may include one or more non-volatile storage devices and/or one or more volatile storage devices. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes DetNet system 152 to perform steps described herein (e.g., steps described herein with reference to the flow charts). In other embodiments, DetNet system 152 may be configured to perform steps described herein without the need for code. That is, for example, PC 1102 may consist merely of one or more ASICs. Hence, the features of the embodiments described herein may be implemented in hardware and/or software.

### SUMMARY OF EMBODIMENTS

A1. A method (500) performed by a network node, the method comprising:
obtaining (s502) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and
transmitting (s504) the information towards a deterministic network, DetNet, controller.

A2. The method of embodiment A1, wherein the network node is a time sensitive communication and time synchronization function, TSCTSF.

A3. The method of embodiment A1 or A2, wherein the port information further includes any one or more of:
at least one port type indicator indicating a type of said at least one port,
at least one IP address of the UPF,
an IP address of a user equipment, UE, coupled to the UPF,
one or more neighboring IP addresses of the UPF,
a subnet address associated with the UPF, or
usage data regarding usage of the port.

A3a. The method of embodiment A3, wherein
said at least one IP address of the UPF, the IP address of the UE, and/or said one or more neighboring IP addresses of the UPF are included in a port management information container, PMIC, and
said at least one port identifier and/or the node identifier is not included in the PMIC.

A4. The method of embodiment A3, wherein said at least one port type indicator indicates whether the type of said at least one port is a 3GPP port or a fixed port.

A5. The method of embodiment A3 or A4, wherein the usage data indicates an amount of traffic passed through the port and/or a time interval during which the port was operational.

A6. The method of any one of embodiments A1-A5, wherein the node identifier is generated based on any one or a combination of an IP address associated with the UPF, a data network name (DNN) associated with a given data network, or single network slice selection assistance information (S-NSSAI) identifying a network slice.

A7. The method of any one of embodiments A1-A6, wherein the node information includes any one or more of:
a domain name associated with the UPF,
an IP address identifying the UPF,
a type indicator indicating whether a network system including the network node is a 3GPP defined system or a router having fixed interfaces, or
network information indicating characteristics of a network provided by the network system including the network node.

A8. The method of embodiment A7, wherein the network system is a fifth generation, 5G, system, 5GS.

A9. The method of any one of embodiments A1-A8, wherein the information is transmitted by the network node towards the DetNet controller via a network exposure function, NEF.

A10. The method of any one of embodiments A1-A9, wherein
said at least one port identifier comprises at least one port index of said at least one port and at least one port name of said at least one port, and
said at least one port name is generated by adding a prefix or a postfix to said at least one port index.

B1. A method (600) performed by a network node, the method comprising:
generating (s602) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and transmitting (s604) the information towards a session management function, SMF.

B2. The method of embodiment B1, wherein the network node is the UPF.

B2a. The method of embodiment B2, further comprising:

receiving a message triggering the UPF to generate said at least one port identifier, wherein the message was sent by the SMF; and as a result of receiving the message, generating said at least one port identifier.

B2b. The method of embodiment B2a, wherein the message is an N4 session establishment request or an N4 session modification request.

B2c. The method of any one of embodiments B1-B2b, wherein
transmitting the information comprises transmitting an N4 session establishment response or an N4 session modification response, and
the N4 session establishment response or then N4 session modification response comprises the information.

B3. The method of any one of embodiments B1-B2c, wherein the port information further includes any one or more of:
at least one port type indicator indicating a type of said at least one port,
at least one IP address of the UPF,
an IP address of a user equipment, UE, coupled to the UPF,
one or more neighboring IP addresses of the UPF,
a subnet address associated with the UPF, or
usage data regarding usage of the port.

B3a. The method of embodiment B3, wherein
said at least one IP address of the UPF, the IP address of the UE, and/or said one or more neighboring IP addresses of the UPF are included in a port management information container, PMIC, and
said at least one port identifier and/or the node identifier is not included in the PMIC.

B4. The method of embodiment B3, wherein said at least one port type indicator indicates whether the type of said at least one port is a 3GPP port or a fixed port.

B5. The method of embodiment B3 or B4, wherein the usage data indicates an amount of traffic passed through the port and/or a time interval during which the port was operational.

B6. The method of any one of embodiments B1-B5, wherein the node identifier is generated based on any one or a combination of an IP address associated with the UPF, a data network name (DNN) associated with a given data network, or single network slice selection assistance information (S-NSSAI) identifying a network slice.

B7. The method of any one of embodiments B1-B6, wherein the node information includes any one or more of:
a domain name associated with the UPF,
an IP address identifying the UPF,
a type indicator indicating whether a network system including the network node is a 3GPP defined system or a router having fixed interfaces, or
network information indicating characteristics of a network provided by the network system including the network node.

B8. The method of embodiment B7, wherein the network system is a fifth generation, 5G, system, 5GS.

B9. The method of any one of embodiments B1-B8, wherein
said at least one port identifier comprises at least one port index of said at least one port and at least one port name of said at least one port, and
said at least one port name is generated by adding a prefix or a postfix to said at least one port index.

C1. A method (700) performed by a network node, the method comprising:
obtaining (s702) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and
transmitting (s704) the information towards a policy control function, PCF.

C2. The method of embodiment C1, wherein the network node is a session management function, SMF.

C2a. The method of embodiment C2, further comprising: transmitting towards the UPF a message triggering the UPF to generate said at least one port identifier; and
as a result of transmitting the message, receiving the information, wherein
the information was transmitted by the UPF.

C2b. The method of embodiment C2a, wherein the message is an N4 session establishment request or an N4 session modification request.

C2. The method of embodiment C2a, wherein
receiving the information comprises receiving an N4 session establishment response or an N4 session modification response, and
the N4 session establishment response or then N4 session modification response comprises the information.

C3. The method of any one of embodiments C1-C2c, wherein the port information further includes any one or more of:
at least one port type indicator indicating a type of said at least one port,
at least one IP address of the UPF,
an IP address of a user equipment, UE, coupled to the UPF,
one or more neighboring IP addresses of the UPF,
a subnet address associated with the UPF, or
usage data regarding usage of the port.

C3a. The method of embodiment C3, wherein
said at least one IP address of the UPF, the IP address of the UE, and/or said one or more neighboring IP addresses of the UPF are included in a port management information container, PMIC, and
said at least one port identifier and/or the node identifier is not included in the PMIC.

C4. The method of embodiment C3, wherein said at least one port type indicator indicates whether the type of said at least one port is a 3GPP port or a fixed port.

C5. The method of embodiment C3 or C4, wherein the usage data indicates an amount of traffic passed through the port and/or a time interval during which the port was operational.

C6. The method of any one of embodiments C1-C5, wherein the node identifier is generated based on any one or a combination of an IP address associated with the UPF, a data network name (DNN) associated with a given data network, or single network slice selection assistance information (S-NSSAI) identifying a network slice.

C7. The method of any one of embodiments C1-C6, wherein the node information includes any one or more of:
a domain name associated with the UPF,
an IP address identifying the UPF,
a type indicator indicating whether a network system including the network node is a 3GPP defined system or a router having fixed interfaces, or
network information indicating characteristics of a network provided by the network system including the network node.

C8. The method of embodiment C7, wherein the network system is a fifth generation, 5G, system, 5GS.

C9. The method of any one of embodiments C1-C8, wherein
said at least one port identifier comprises at least one port index of said at least one port and at least one port name of said at least one port, and
said at least one port name is generated by adding a prefix or a postfix to said at least one port index.

C10. The method of any one of embodiments C1-C9, wherein transmitting the information towards the PCF comprises transmitting an Npcf_SMPolicyControl_Update request.

D1. A method (800) performed by a network node, the method comprising:
obtaining (s802) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and transmitting (s804) the information towards a time sensitive communication and time synchronization function, TSCTSF.

D2. The method of embodiment D1, wherein the network node is a policy control function.

D3. The method of embodiment D1 or D2, wherein the port information further includes any one or more of:
at least one port type indicator indicating a type of said at least one port,
at least one IP address of the UPF,
an IP address of a user equipment, UE, coupled to the UPF,
one or more neighboring IP addresses of the UPF,
a subnet address associated with the UPF, or
usage data regarding usage of the port.

D3a. The method of embodiment D3, wherein
said at least one IP address of the UPF, the IP address of the UE, and/or said one or more neighboring IP addresses of the UPF are included in a port management information container, PMIC, and
said at least one port identifier and/or the node identifier is not included in the PMIC.

D4. The method of embodiment D3, wherein said at least one port type indicator indicates whether the type of said at least one port is a 3GPP port or a fixed port.

D5. The method of embodiment D3 or D4, wherein the usage data indicates an amount of traffic passed through the port and/or a time interval during which the port was operational.

D6. The method of any one of embodiments D1-D5, wherein the node identifier is generated based on any one or a combination of an IP address associated with the UPF, a data network name (DNN) associated with a given data network, or single network slice selection assistance information (S-NSSAI) identifying a network slice.

D7. The method of any one of embodiments D1-D6, wherein the node information includes any one or more of:
a domain name associated with the UPF,
an IP address identifying the UPF,
a type indicator indicating whether a network system including the network node is a 3GPP defined system or a router having fixed interfaces, or
network information indicating characteristics of a network provided by the network system including the network node.

D8. The method of embodiment D7, wherein the network system is a fifth generation, 5G, system, 5GS.

D9. The method of any one of embodiments D1-D8, wherein
said at least one port identifier comprises at least one port index of said at least one port and at least one port name of said at least one port, and
said at least one port name is generated by adding a prefix or a postfix to said at least one port index.

D10. The method of any one of embodiments D1-D9, wherein
obtaining the information comprises receiving an Npcf_SMPolicyControl_Update request, and
the Npcf_SMPolicyControl_Update request was transmitted by the SMF.

E1. A method (900) performed by a deterministic network, DetNet, controller, the method comprising:
receiving (s902) information comprising port information and/or node information, wherein
   the information was transmitted by a network node
   the port information includes at least one port identifier identifying at least one port which is assigned to a Packet Data Unit, PDU, session and/or which is associated with a user plane function, UPF, and
   the node information includes a node identifier identifying the UPF; and
using the received information, generating (s904) topology information indicating topology of the logical network node.

E2. The method of embodiment E1, wherein the network node is a time sensitive communication and time synchronization function, TSCTSF or a network exposure function, NEF.

E3. The method of embodiment E1 or E2, wherein the port information further includes any one or more of:
at least one port type indicator indicating a type of said at least one port,
at least one IP address of the UPF,
an IP address of a user equipment, UE, coupled to the UPF,
one or more neighboring IP addresses of the UPF,
a subnet address associated with the UPF, or
usage data regarding usage of the port.

E3a. The method of embodiment E3, wherein
said at least one IP address of the UPF, the IP address of the UE, and/or said one or more neighboring IP addresses of the UPF are included in a port management information container, PMIC, and
said at least one port identifier and/or the node identifier is not included in the PMIC.

E4. The method of embodiment E3, wherein said at least one port type indicator indicates whether the type of said at least one port is a 3GPP port or a fixed port.

E5. The method of embodiment E3 or E4, wherein the usage data indicates an amount of traffic passed through the port and/or a time interval during which the port was operational.

E6. The method of any one of embodiments E1-E5, wherein the node identifier is generated based on any one or a combination of an IP address associated with the UPF, a data network name (DNN) associated with a given data network, or single network slice selection assistance information (S-NSSAI) identifying a network slice.

E7. The method of any one of embodiments E1-E6, wherein the node information includes any one or more of:
a domain name associated with the UPF,
an IP address identifying the UPF,
a type indicator indicating whether a network system including the TSCTSF is a 3GPP defined system or a router having fixed interfaces, or
network information indicating characteristics of a network provided by the network system including the TSCTSF.

E8. The method of embodiment E7, wherein the network system is a fifth generation, 5G, system, 5GS.

E9. The method of any one of embodiments E1-E8, wherein said at least one port identifier comprises at least one port index of said at least one port and at least one port name of said at least one port, and said at least one port name is generated by adding a prefix or a postfix to said at least one port index.

F1. A computer program (1043) comprising instructions (1044) which when executed by processing circuitry (1002) cause the processing circuitry to perform the method of any one of embodiments A1-E9.

F2. A carrier containing the computer program of embodiment F1, wherein the carrier is one of an electronic signal, an optical signal, a radio signal, and a computer readable storage medium.

G1. A network node (116), the network being configured to:
obtain (s502) information comprising port information and/or node information, wherein
   the port information includes at least one port identifier identifying at least one port which is assigned to a Packet Data Unit, PDU, session and/or which is associated with a user plane function, UPF, and
   he node information includes a node identifier identifying the UPF; and
transmit (s504) the information towards a deterministic network, DetNet, controller.

G2. The network node of embodiment G1, wherein the network node is further configured to perform the method of any one of embodiments A2-A10.

H1. A network node (108), the network being configured to:
generate (s602) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and
transmit (s604) the information towards a session management function, SMF.

H2. The network node of embodiment H1, wherein the network node is further configured to perform the method of any one of embodiments B2-B9.

I1. A network node (112), the network being configured to:
obtain (s702) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and transmit (s704) the information towards a policy control function, PCF.

I2. The network node of embodiment 11, wherein the network node is further configured to perform the method of any one of embodiments C2-C10.

J1. A network node (114), the network node being configured to:
obtain (s802) information comprising port information and/or node information, wherein
   the port information includes at least one port identifier identifying at least one port which is assigned to a Packet Data Unit, PDU, session and/or which is associated with a user plane function, UPF, and
   the node information includes a node identifier identifying the UPF; and
transmit (s804) the information towards a time sensitive communication and time synchronization function, TSCTSF.

J2. The network node of embodiment J1, wherein the network node is further configured to perform the method of any one of embodiments D2-D10.

K1. A deterministic network, DetNet, controller (156), being configured to:
receive (s902) information comprising port information and/or node information, wherein
   the information was transmitted by a network node the port information includes at least one port identifier identifying at least one port which is assigned to a Packet Data Unit, PDU, session and/or which is associated with a user plane function, UPF, and
   the node information includes a node identifier identifying the UPF; and
using the received information, generate (s904) topology information indicating topology of the logical network node.

K2. The network node of embodiment K1, wherein the network node is further configured to perform the method of any one of embodiments E2-E9.

L1. An apparatus (1000), the apparatus comprising: a memory (1041); and processing circuitry (1002) coupled to the memory, wherein the apparatus is configured to perform the method of any one of embodiments A1-E9.

### Conclusion

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-52. (canceled)

53. A method performed by a time sensitive communication and time synchronization function (TSCTSF), the method comprising:
obtaining first information comprising port information and/or node information, wherein
if the first information comprises the port information, then the port information comprises at least one port identifier identifying at least one port which is assigned to a packet data unit (PDU) session and/or which is associated with a user plane function (UPF), and
if the first information comprises the node information, then the node information comprises a node identifier identifying a UPF; and,
transmitting towards a deterministic network (DetNet) controller second information generated based on the first information.

54. The method of claim 53, wherein
the first information comprises the node information,
the second information comprises information determined based on the node information,
the information determined based on the node information is a node identifier identifying a 5G system (5GS) node,
the second information comprises a node identifier identifying the 5GS node, and
the node identifier included in the second information is an IP address for signaling between the network node and the DetNet controller.

55. The method of claim 53, wherein
the first information comprises the port information, and
the second information comprises information determined based on the port information,
the information determined based on the port information comprises at least one interface identifier, and
the at least one interface identifier is determined based on the at least one port identifier.

56. The method of claim 53, wherein
the first information comprises the port information,
the second information comprises information determined based on the port information,
the information determined based on the port information comprises at least one interface name, and
the at least one interface name is determined based on the at least one port identifier.

57. The method of claim 53, wherein the port information further comprises:
a port type indicator indicating a type of the at least one port,
an IP address of the UPF,
an IP address of a user equipment (UE) coupled to the UPF,
a neighboring IP address of the UPF,
a subnet address associated with the UPF, and/or
usage data regarding usage of the port.

58. The method of claim 57, wherein
the IP address of the UPF, the IP address of the UE, and/or the neighboring IP address are included in a port management information container (PMIC), and
the port identifier and/or the node identifier is not included in the PMIC.

59. The method of claim 58, wherein the port type indicator indicates either a 3GPP port type or a fixed port type.

60. The method of claim 57, wherein the usage data indicates an amount of traffic passed through the port and/or a time interval during which the port was operational.

61. The method of claim 53, wherein the node identifier is generated based on any one or a combination of an IP address associated with the UPF, a data network name (DNN) associated with a given data network, or single network slice selection assistance information (S-NSSAI) identifying a network slice.

62. The method of claim 53, wherein the node information comprises any one or more of:
a domain name associated with the UPF,
an IP address identifying the UPF,
a type of indicator indicating whether a network system including the network node is a 3GPP defined system or a router having fixed interfaces, or
network information indicating characteristics of a network provided by the network system including the network node;
wherein the network system is a fifth generation, 5G, system, 5GS.

63. The method of claim 53, wherein
the at least one port identifier comprises at least one port index of the at least one port and at least one port name of the at least one port, and
the at least one port name is generated by adding a prefix or a postfix to the at least one port index.

64. A method performed by a deterministic network (DetNet) controller, the method comprising:
receiving information generated based on port information and/or node information, wherein
the information was generated by a network node,
the port information comprises at least one port identifier identifying at least one port which is assigned to a Packet Data Unit (PDU) session and/or which is associated with a user plane function (UPF), and
the node information comprises a node identifier identifying the UPF; and
using the received information, generating topology information indicating topology of the logical network node.

65. The method of claim 64, wherein the network node is a time sensitive communication and time synchronization function (TSCTSF) or a network exposure function (NEF).

66. The method of claim 64, wherein the port information further comprises any one or more of:
at least one port type indicator indicating a type of the at least one port,
at least one IP address of the UPF,
an IP address of a user equipment, UE, coupled to the UPF,
one or more neighboring IP addresses of the UPF,
a subnet address associated with the UPF, or
usage data regarding usage of the port.

67. The method of claim 66, wherein
the at least one IP address of the UPF, the IP address of the UE, and/or the one or more neighboring IP addresses of the UPF are included in a port management information container, PMIC, and
the at least one port identifier and/or the node identifier is not included in the PMIC; and,
wherein the at least one port type indicator indicates whether the type of the at least one port is a 3GPP port or a fixed port; and,
wherein the usage data indicates an amount of traffic passed through the port and/or a time interval during which the port was operational.

68. The method of claim 64, wherein the node identifier is generated based on any one or a combination of an IP address associated with the UPF, a data network name (DNN) associated with a given data network, or single network slice selection assistance information (S-NSSAI) identifying a network slice.

69. The method of claim 64, wherein the node information comprises any one or more of:
a domain name associated with the UPF,
an IP address identifying the UPF,
a type of indicator indicating whether a network system including the TSCTSF is a 3GPP defined system or a router having fixed interfaces, or
network information indicating characteristics of a network provided by the network system including the TSCTSF;
wherein the network system is a fifth generation, 5G, system, 5GS.

70. The method of claim 64, wherein
the at least one port identifier comprises at least one port index of the at least one port and at least one port name of the at least one port, and
the at least one port name is generated by adding a prefix or a postfix to the at least one port index.

71. A network node, the network node comprising:
a transmitter;
memory; and
processing circuitry, wherein the network node is configured to perform a method comprising:
obtaining first information comprising port information and/or node information, wherein
if the first information comprises the port information, then the port information comprises at least one port identifier identifying at least one port which is assigned to a packet data unit (PDU) session and/or which is associated with a user plane function (UPF), and
if the first information comprises the node information, then the node information comprises a node identifier identifying a UPF; and,
using the transmitter to transmit toward a deterministic network (DetNet) controller second information generated based on the first information.

72. A deterministic network (DetNet) controller, the DetNet controller comprising:
a receiver for receiving information generated based on port information and/or node information, wherein
the information was generated by a network node,
the port information comprises at least one port identifier identifying at least one port which is assigned to a Packet Data Unit (PDU) session and/or which is associated with a user plane function (UPF), and
the node information comprises a node identifier identifying the UPF;
memory; and
processing circuitry, wherein the DetNet controller is configured to perform a method comprising:
using the received information, generating topology information indicating topology of the logical network node.
